(19) United States
(12) Patent Application Publication
(10) Pub. No.: US 2005/0216257 A1
(43) Pub. Date: Sep. 29, 2005

(54) Sound information reproducing apparatus and method of preparing keywords of music data

(75) Inventors: Masashi Tanabe, Saitama (JP); Tsuyoshi Sato, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/079,465

(22) Filed: Mar. 15, 2005

(30) Foreign Application Priority Data
Mar. 18, 2004 (JP) 2004-077519

(51) Int. Cl. G10L 11/00; G06F 15/00; A63H 5/00; G10H 7/00; G04B 13/00

(52) U.S. Cl. 704/200

(57) ABSTRACT

A storing unit stores a plurality of music data and music data relating information that relates a keyword to each of the music data, a reproducing unit reproduces the music data stored in the storing unit, a searching unit searches the storing unit for music data based on the music data relating information when a user inputs a keyword, an extracting unit extracts characteristics of the music data while the music data are reproduced by the reproducing unit, and a preparing unit prepares a keyword using the characteristics of the music data extracted by the extracting unit, relates the prepared keywords to the music data, and causes the storing unit to store the related data.

### BACKGROUND OF THE INVENTION

1) Field of the Invention

The present invention relates to a technology for searching music data in a recording medium.

2) Description of the Related Art

Due to the recent technological progress, it has become possible to make small but high capacity recording media. Moreover, the progress in the data compression technology, such as MP3 (MPEG-1 audio layer 3), has made it possible to compress music data such as songs and music without causing deterioration of the sound quality. As a result, it has become possible to store quite a large amount of music data in the recording media. In view of these facts, small but large capacity sound information reproducing apparatus have appeared in the market. An example of such a sound information reproducing device is a palm-sized portable sound information reproducing device having a hard disc for storing music data and an arrangement for reproducing the music data. Another example is the car navigation system.

When a large amount of music data is recorded in a recording medium, it is cumbersome to select and play the desired music data. One approach that is currently used is to assign a keyword to each music data in a recording medium. The user specifies a keyword for each music data and the keyword is registered corresponding to the music data. When the user inputs a keyword, a music data corresponding to the keyword is retrieved and reproduced. Such a technology is disclosed in Gazette of Japanese Patent Application Laid-Open Publication No. 2003-91540.

The users specify the keywords according to mood or mere impression. Therefore, it is easy for the user to forget the keywords. Moreover, there are cases in which a plurality of users uses one sound information reproducing apparatus. For example, a plurality of users uses one car navigation system. In such a case, different users may specify different words as the keywords. As a result, it is difficult to find the desired music data.

### SUMMARY OF THE INVENTION

It is an object of the present invention to at least solve the problems in the conventional technology.

According to an object of the present invention, an audio information reproducing apparatus includes a storing unit that stores therein a plurality of music data and music data relating information that relates a keyword to each of the music data; a reproducing unit that reproduces the music data; an acquiring unit that acquires a keyword from a user; a searching unit that searches the storing unit for music data relating to music data relating information corresponding to the keyword acquired; an extracting unit that extracts characteristics of music data while the music data reproduces the reproducing unit; and a preparing unit that prepares a keyword using the characteristics of the music data extracted by the extracting unit, causes the storing unit to store the music data and the keyword prepared in a correlated form.

According to another object of the present invention, an audio information reproducing apparatus includes a storing unit that stores therein a plurality of music data and music data relating information that relates a keyword to each of the music data; a reproducing unit that reproduces the music data; an acquiring unit that acquires a keyword from a user; a searching unit that searches the storing unit for music data relating to music data relating information corresponding to the keyword acquired; a voice extracting unit that extracts voice from the music data reproduced by the reproducing unit; a speech recognizing unit that performs voice recognition with respect to the extracted voice to extract a sequence of words; a keyword extracting unit that extracts a word selected from the recognized words based on a predetermined standard as the keyword, relates the extracted keyword to the music data, and causes the storing unit to store the keyword.

According to still another object of the present invention, a method of preparing keywords for a plurality of music data used in an audio information reproducing unit that searches music data using a keyword and reproduces a desired music data includes extracting characteristics of the music data while the music data are reproduced; and preparing a keyword using the characteristics of the music data extracted at the extracting and relating the keyword to the music data.

According to still another object of the present invention, a method of preparing keywords for a plurality of music data used in an audio information reproducing unit that searches music data using a keyword and reproduces a desired music data includes extracting voice of the music data while the music data are reproduced; performing speech recognition with respect to the voice extracted at the extracting as a sequence of words; extracting a word out of the recognized words based on a predetermined standard as the keyword and relating the keyword to the music data.

The other objects, features, and advantages of the present invention are specifically set forth in or will become apparent from the following detailed description of the invention when read in conjunction with the accompanying drawings.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an audio information reproducing apparatus according to an embodiment of the present invention;

FIG. 2 is a diagram of an example of a structure of a music database;

FIG. 3 is a flowchart of a process procedure for preparing a keyword;

FIG. 4 is a flowchart of a process procedure for searching a music data using the keyword;

FIG. 5 is a block diagram of an audio information reproducing apparatus according to an example of the present embodiment; 4,

FIG. 6 is a flowchart of a process procedure for preparing a keyword in the example shown in FIG. 5;

FIG. 7 is a diagram of an example of a reproduction screen during reproduction of music data;

FIG. 8 is a flowchart of a sound recognition processing;

FIG. 9 is a diagram of an example of a preparing screen during preparing a keyword;

FIG. 10A is a schematic of an exemplary keyword selection screen;

FIG. 10B is a schematic of another exemplary keyword selection screen;

FIG. 11 is a flowchart of a process procedure for searching music data using the keyword; and

FIG. 12 is a schematic of an exemplary piece searching screen.

### DETAILED DESCRIPTION

Exemplary embodiments of the present invention are explained next with reference to the accompanying drawings.

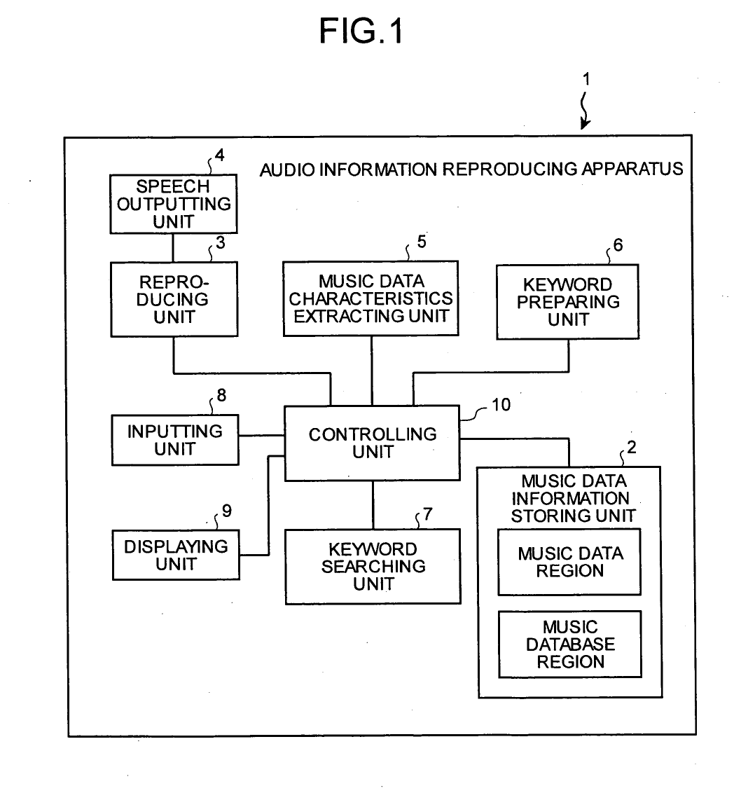

FIG. 1 is a block diagram of a sound information reproducing apparatus 1 according to an embodiment of the present invention. The audio information reproducing apparatus 1 includes a music data information storing unit 2, a reproducing unit 3, a voice outputting unit 4, a music data characteristics extracting unit 5, a keyword preparing unit 6, a keyword searching unit 7, a inputting unit 8, a displaying unit 9, and a controlling unit 10.

The music data information storing unit 2 stores music data and a music database. The music data constitute a song or music to be reproduced. The music database manages keywords to be assigned to music data by relating the keywords to the music data. The music data information storing unit 2 includes a music data region where the music data are stored and a music database region where the music database is stored. The term “music data” as used herein refers to data that contain sounds such as songs and musics. The music database is sometimes referred to as “music data relating information”.

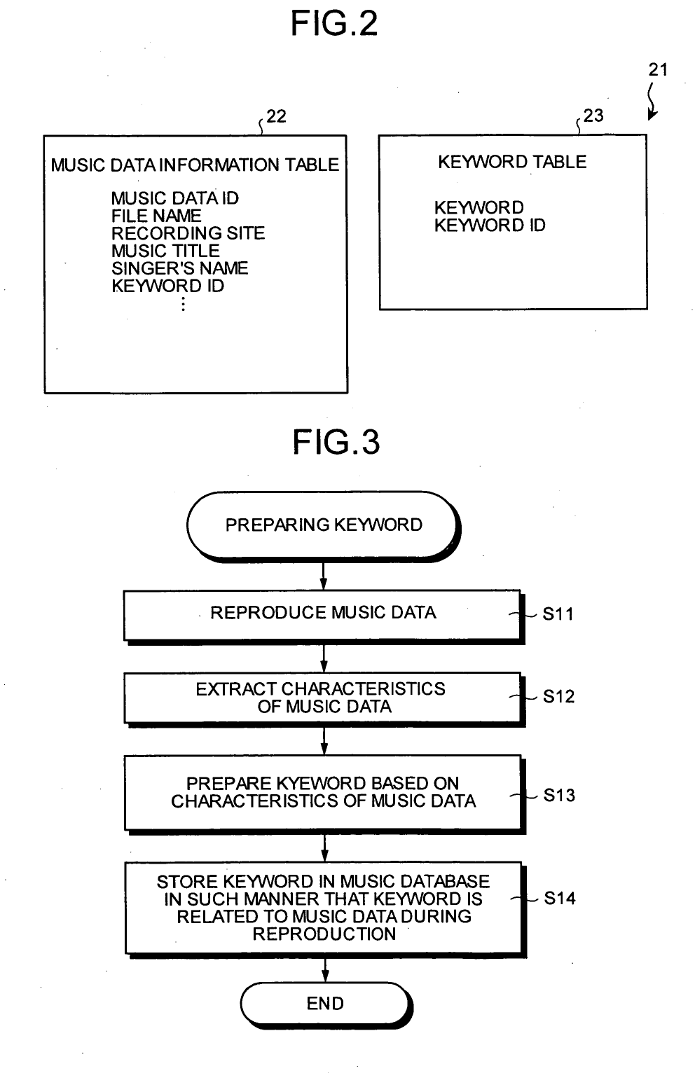

The music database stores the music data and the keywords assigned to the music data in a related manner in the music data information storing unit 2. The keywords that can be used include characteristics extracted from the music data. For example, the self-sufficient words or nouns contained in the lyrics that constitute the music data may be used as the keywords. Also, the genre and tune of the music data, such as rock and roll, folk song, pops, and popular ballad may be used as the keywords. FIG. 2 is a diagram of an example of a structure of the music database. A music database 21 of this example includes a music data information table 22 that stores information on music data to be stored in the music data information storing unit 2 and a keyword table 23 that stores keywords that are assigned to the music data. The music data information table 22 and the keyword table 23 constitute a related database configuration. The music data information table 22 includes items of “music data identification (ID)” that is assigned to recognize uniquely the music data to be stored in the music database, “file name” that is a name assigned to the file of the music data, “recording site” that indicates the site where the music data is recorded, “music title” of the music data, “keyword identification (ID)” that indicates the keyword related to the music data. In addition, the music data information table 22 may include, for example, “singer's name” that is the name of a singer who sings the song in the music data. The keyword ID is an item used for making relation to the keywords in the keyword table 23. The keyword table 23 includes items of “keyword” and “keyword ID” that uniquely recognizes the keywords. The music data in the music data information table 22 and the keywords are related with the keyword ID's.

The reproducing unit 3 is capable of reproducing the music data selected by the user out of the music data recorded in the music data information storing unit 2 with converting the music data from digital data into analog data. The voice outputting unit 4 includes a voice outputting device such as a speaker and is capable of outputting the music data converted into the analog data by the reproducing unit 3 as sounds.

The music data characteristics extracting unit 5 when in a keyword preparing mode is capable of extracting characteristics from the music data reproduced based a predetermined standard on preparing the keywords. For example, when the tune is the standard of preparing the keywords, the tune of the music data reproduced is extracted. In this case, the music data characteristics extracting unit 5 holds tune information that is necessary for determining the tune of the music data in advance, compares the tune of the music data during reproduction with the tune information, and extracts the tune that matches as the characteristics of the music data. For example, a word contained in the lyrics is the standard of preparing the keywords, the music data characteristics extracting unit 5 recognizes the lyrics from the music data during reproduction and extracts the word.

The keyword preparing unit 6 prepares the keywords based on the characteristics of the music data extracted by the music data characteristics extracting unit 5 and storing the keywords in the music database in such a manner that the keywords are related to the characteristics of the music data during reproduction. For example, when the tune of the music data is used as the standard on preparing the keywords, the keyword preparing unit 6 holds the tune and the music data characteristics information that contains the keyword related to the tune, and judges the genre related to the tune and extracted by the music data characteristics extracting unit 5 using the music data characteristics information. The keyword preparing unit 6 relates the genre to the music data during reproduction as a keyword and stores the genre in the music database. When, for example, a word contained in the lyrics is the standard for preparing a keyword, the keyword preparing unit 6 relates an extracted word or a word selected out of extracted words according to a predetermined standard to the music data during reproduction and stores the word in the music database 21.

The keyword searching unit 7 is capable of searching the music data related to the keyword that is input by the user through the inputting unit 8 from the music database 21. The results of search are output to the displaying unit 9.

The displaying unit 9 includes a displaying device such as a liquid crystal display and presents various pieces of information, such as information on the music during reproduction, a search screen for searching the music, and a search result screen for displaying search results, to the user.

The inputting unit 8 includes an inputting device such as a keyboard, a button, or a touch panel. The user inputs various commands for operating the audio information reproducing apparatus 1.

The controlling unit 10 controls the operations of the respective units.

The keyword preparing process and music data searching process using the keywords prepared by the keyword preparing process in the audio information reproducing apparatus 1 having the above configuration is explained. FIG. 3 is a flowchart of a process procedure for preparing a keyword. The process procedure starts when a user gives instruction to start the process during reproduction of the music data. More particularly, when a music data recorded in the music data information storing unit 2 is being reproduced by the reproducing unit 3 (step S11), the music data characteristics extracting unit 5 extracts the characteristics of the music data that is being reproduced (step S12). The keyword preparing unit 6 prepares a keyword based on the extracted characteristics of the music data (step S13). The prepared keyword is stored in the music database 21 in a related manner with the music data (step S14) and the keyword preparing process is completed.

The reproduction processes includes those recording processes when the music data during reproduction are dubbed into other recording medium such as compact disc (CD) or mini disk (MD) and those recording processes when conversely music data recorded in other recording medium such CD or MD are dubbed into the music data information storing unit 2.

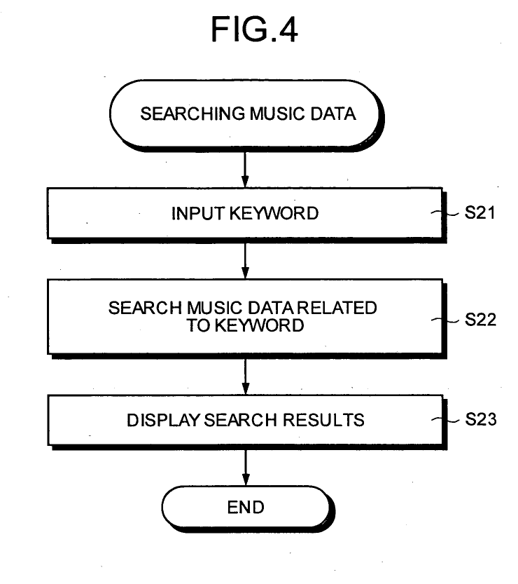

FIG. 4 a flowchart of a process procedure for searching a music data using a keyword. The process starts when a user gives instruction to start the process while the audio information reproducing apparatus 1 is active. First, the user inputs an appropriate keyword through the inputting unit 8 (step S21). The keyword can be input in various manners. For example, the user can input a word directly through an inputting device such as a keyboard or may select one of keywords in a list displayed in the displaying unit 9 from the keyword table 23 in the music database 21 by indicating the keyword through the inputting unit 8.

The keyword searching unit 7 searches the music data that is related to the input keyword from the music database 21 (step S22). The displaying unit 9 displays the search results (step S23) and the searching process is completed. The user may use the search results in reproducing process or selecting process for reproducing the objective music.

According to this embodiment, the characteristics extracted from music data are related to the music data, so that the user who knows the music data can search the music data based on the universal characteristic that the music data themselves have. This enables efficient extraction of desired music data whosoever users may be when the audio information reproducing apparatus 1 that records therein a huge number of music data is used by a plurality of users. In addition, when preparing a keyword, the user only needs to give instruction to start the keyword preparing process. This avoids the user's trouble. For example, even when the audio information reproducing apparatus 1 is mounted on a movable body such as a car and the user is a driver, the safety of driving can be secured.

The present invention is explained in more detail taking an example of preparing a keyword from lyrics contained in the music data. However, the present invention should not be considered to be limited to this example.

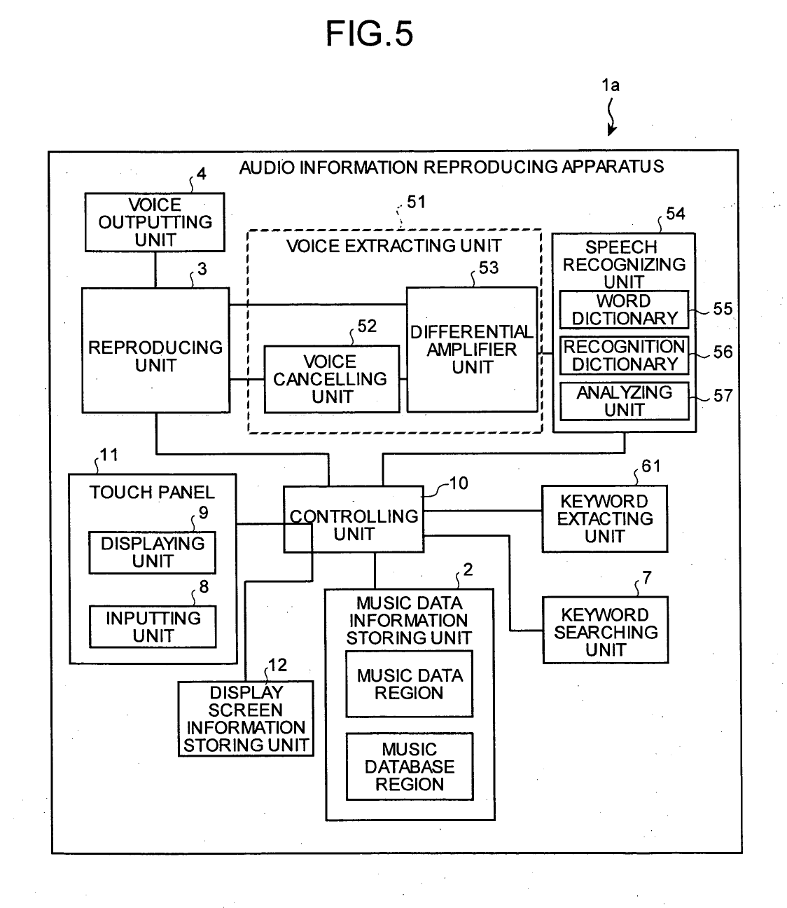

FIG. 5 is a block diagram of an audio information reproducing apparatus 1a according to an embodiment of the present embodiment. The audio information reproducing apparatus 1a includes the music data information storing unit 2 that sores music data of a music to be reproduced and a music database that manages a keyword to be assigned to the music data, the reproducing unit 3 that reproduces the music data selected by the user out of the music data stored in the music data information storing unit 2 after converting the selected music data from digital data into analog data, the voice outputting unit 4 that outputs the analog data from the reproducing unit 3 as sound, a voice extracting unit 51 that extracts a portion of a song from the music data, a speech recognizing unit 54 that recognizes voice from the extracted song to obtain a sequence of words, a keyword extracting unit 61 that extracts a keyword from the sequence of words of the recognized speech, the keyword searching unit 7 that searches the music data that corresponds to the input keyword, a touch panel 11 that displays necessary information to the user and with which the user inputs, a display screen information storing unit 12 that stores the screen information to be displayed in the touch panel, and the controlling unit 10 that controls the respective units. The parts and components that have the same or similar constructions as those explained in FIG. 1 are indicated by the same reference numerals and explanation thereof is omitted. The configuration of the music database 21 is the same as that shown in FIG. 2. The keywords stored in the keyword table 23 are words (nouns) contained in the lyrics of the songs.

The voice extracting unit 51 extracts only a vocal component from the music data constituted by the music and song (hereafter, referred to as “vocal”) when in a keyword preparing state. The voice extracting unit 51 includes a voice canceling unit 52 and a differential amplifier unit 53. The voice canceling unit 52 includes a vocal canceling circuit and is capable of canceling the vocal component from the music data. The way the voice canceling unit 52 cancels the voice is as follows. When voice data, such as commercially available music CDs are prepared (that is, recorded), in most cases, the singer stands in the center of left (L) and right (R) microphones. Accordingly, the vocal component is a stereo source that is recorded in such a manner that L and R data hare of the same level and the same phase. Utilizing this, a difference signal (L-R) between the two-channel signals (L and R) is generated to attenuate only the vocal component of the singer. The music data from which the voice canceling unit 52 canceled the vocal component (hereinafter, “music component”) are output to the differential amplifier unit 53.

The differential amplifier unit 53 is capable of acquiring the music data input from the reproducing unit 3 and the music component generated by the voice canceling unit 52 as inputs, and obtaining a difference between the music data and the music component to extract only the vocal component in the music data.

The speech recognition unit 54 is capable of recognizing speech in the vocal component of the music data generated by the differential amplifier unit 53. The speech recognizing unit 54 includes a word dictionary 55 that describes acoustic characteristics of phoneme, which is the smallest unit of the voice of a human, a recognition dictionary 56 that records connections of phonemes that constitute words, and an analyzing unit 57 that analyzes the vocal component of the music data input. The analyzing unit 57 analyzes the vocal component of the input music data, calculates the acoustic characteristics of the vocal component, extracts a word that has acoustic characteristics closest to the acoustic characteristics of the vocal component of the input music data from the words described in the recognition dictionary 56, and outputs the extracted word as the result of the speech recognition.

The keyword extracting unit 61 is capable of taking the word that serves as a keyword out of the speech recognition results output by the speech recognizing unit 54, relating the word to the music data being currently reproduced, and storing the related word in the music data information storing unit 2. The word that serves as a keyword may be either a self-sufficient word obtained by removing particles and auxiliary verbs, or noun contained in the speech recognition results. The keyword extracting unit 61 extracts a keyword from the speech recognition results consulting a terminology dictionary (not shown) that contains self-sufficient words and nouns. The keyword table 23 in the music database 21 may be set as the terminology dictionary. In this case, each of the words in the terminology dictionary must be preliminarily assigned a keyword ID that can uniquely recognize the keyword.

The touch panel 11 is configured to have a touch sensor that detects a touch by the user on the surface of the displaying unit such as liquid crystal displaying device by pressure or shutoff of light. Thus, the touch panel 11 includes the inputting unit 8 and the displaying unit 9 shown in FIG. 1. The display screen information storing unit 12 stores display screen information containing the function of an inputting button displayed on the touch panel 11. The display screen information storing unit 12 stores display screen information, for example, a reproduction screen when the music data is reproduced as described later, a screen during keyword preparation, and a keyword selection screen.

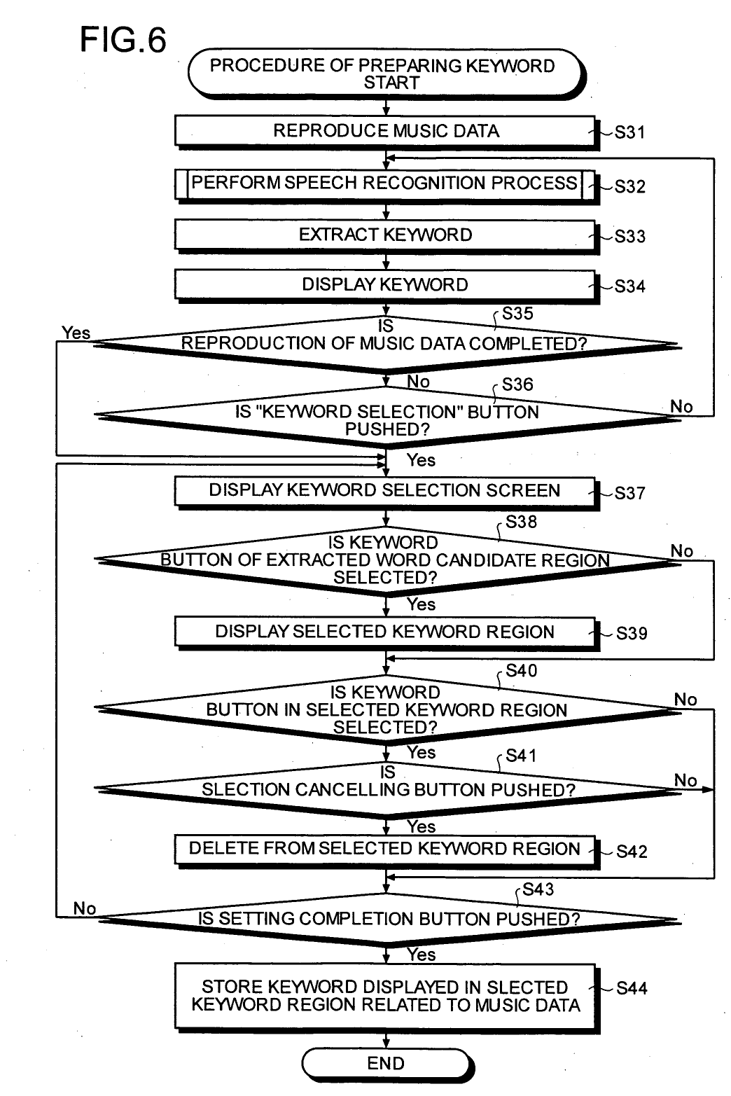

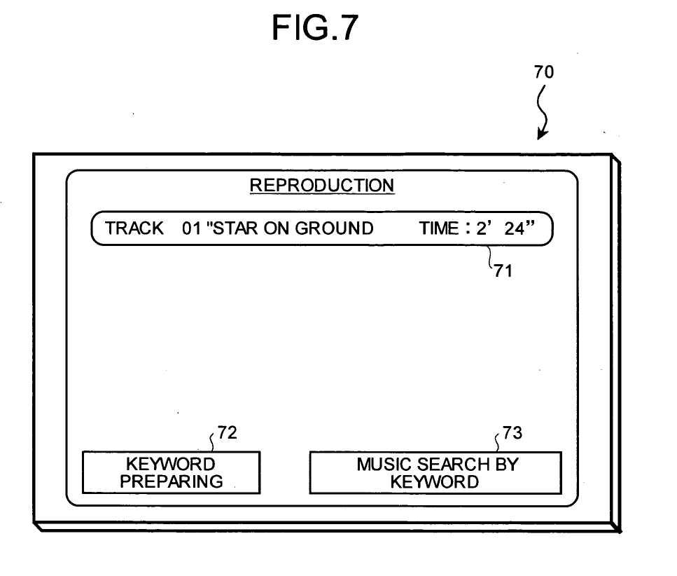

Specific examples of keyword preparing process and music data searching process using the keyword in the audio information reproducing apparatus 1a with the above configuration are explained. First, the keyword preparing process in the audio information reproducing apparatus 1a is explained. FIG. 6 is a flowchart of a process procedure for preparing a keyword in the present example. FIG. 7 is a diagram of an example of a reproduction screen during reproduction of music data. On a reproduction screen 70, music information 71 on music data during reproduction (hereinafter, also referred to as “music”) is displayed and a “keyword preparing” button 72 that performs keyword preparing process and a “keyword music searching” button that performs searching of musics using keywors are provided. By contacting the positions on the displaying unit 9 where the buttons 72 and 73 are displayed, the touch panel 11 detects the positions and realizes the processes that correspond to the buttons 72 and 73. When the keyword preparing button 72 in the reproduction screen 70 shown in FIG. 7 is pushed, the keyword preparing process shown in FIG. 6 starts.

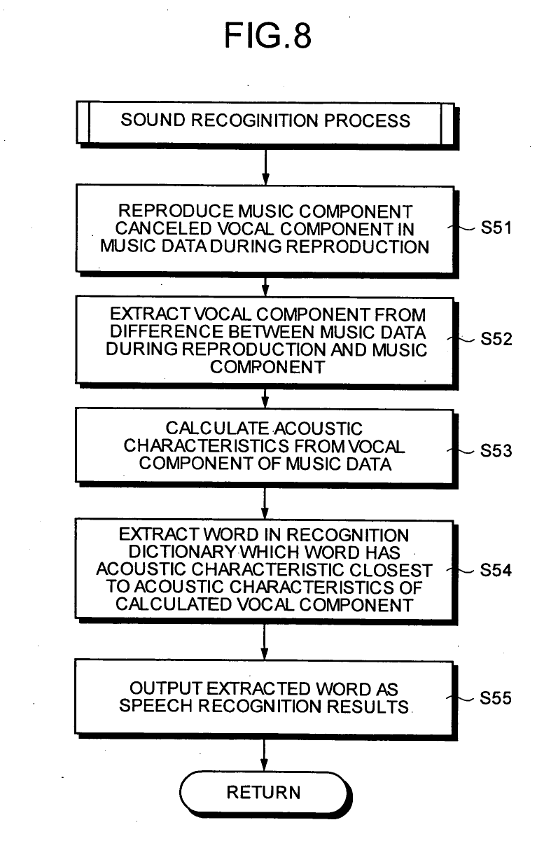

That is, when the reproducing unit 3 is reproducing a music data stored in the music data information storing unit 2 (step S31), speech recognition process is performed (step S32). FIG. 8 is a flowchart for explaining details of sound recognition processing. First, the voice canceling unit 52 cancels the vocal component in the music data during reproduction that is input from the reproducing unit 3 to generate a music component (step S51). The differential amplifier unit 53 forms a difference between the music data input from the reproducing unit 3 and during reproduction and music component of the music data input from the voice canceling unit 52 in a state that the music data and the music component and extracts the vocal component from the difference between the two (step S52). The speech recognizing unit 54 analyzes the extracted vocal component of the music data and calculates the acoustic characteristics of the speech from waveform thereof (step S53). The speech recognizing unit 54 then extracts a word in the recognition dictionary 56 which word has acoustic characteristics closest to the calculated acoustic characteristics of the vocal component of the music data (step S54), and outputs the results as speech recognition results (step S55). Thus, the speech recognition process is completed.

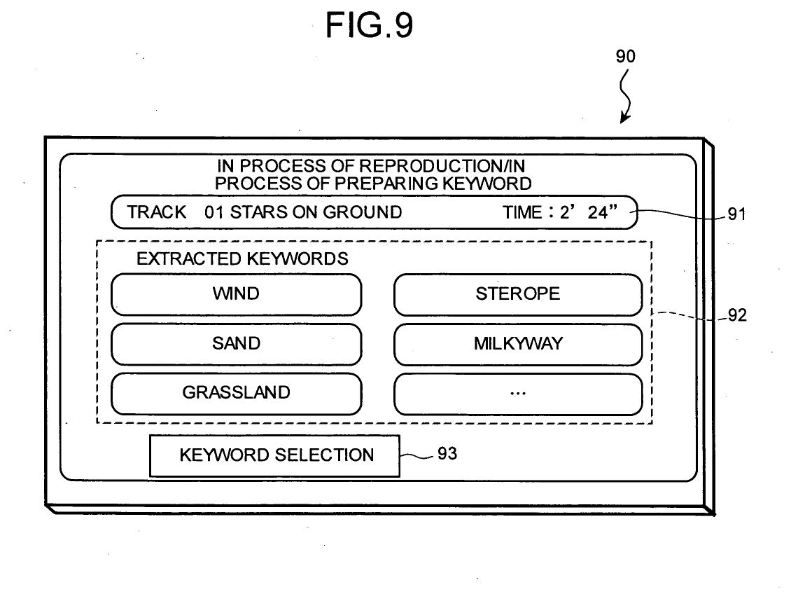

From the speech recognition results obtained by the speech recognition process, the keyword extracting unit 61 extracts a keyword (step S33). For example, the keyword extracting unit decomposes the speech recognition results into self-sufficient words and ancillary words, extracts only self-sufficient words consulting the terminology dictionary that the keyword extracting unit 61 has, or extracts only nouns in the self-sufficient words. The extracted keyword is displayed on the touch panel 11 (step S34). FIG. 9 is a diagram of an example of a preparing screen during preparing a keyword. On a keyword preparing screen 90, music information 91 that is information of a music that is in process of reproduction and the keyword extracted by the keyword extracting unit 61 are displayed in a keyword display region 92. The keyword preparing screen 90 is provided a “keyword selection” button 93 that switches to a keyword selection screen that allows the user to select a keyword from the extracted keywords.

Thereafter, whether reproduction of the music data is completed is judged (step S35). When the reproduction of the music data is not completed (step S35, NO), whether the keyword selection button 93 on the keyword preparing screen 90 was pushed is judged (step S36). When the keyword selection button 93 was not pushed (step S36, NO), the control returns to the step S32 and the above process is repeated until the reproduction of the music data is completed. That is, keywords are continued to be added one after one to the keyword display region 92 on the keyword preparing screen 90 until the reproduction of the music data is completed. In this example, the nouns contained in the lyrics, such as “WIND”, “STEROPE”, “SAND”, and “MILKYWAY” are added one after one.

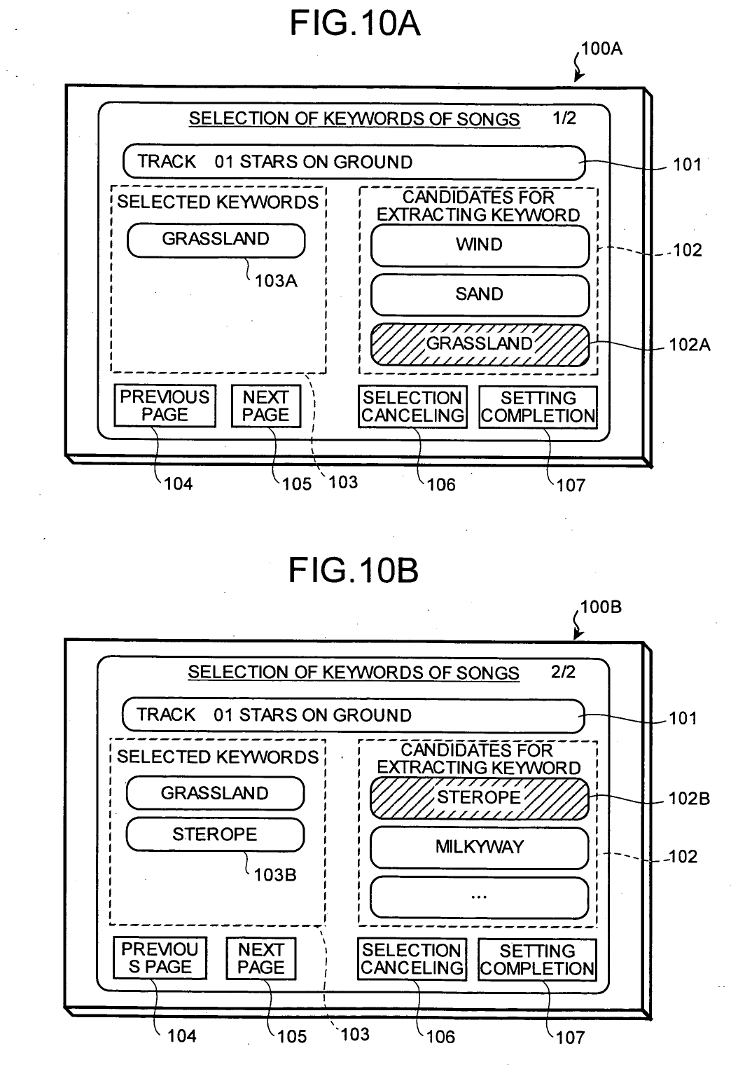

When the keyword selection button 93 was pushed at the step S36 (step S36, YES), or when the reproduction process was completed at the step S35 (step S35, YES), the touch panel 11 displays the keyword selection screen (step S37). FIG. 10A and FIG. 10B are diagrams of examples of the keyword selection screen. On keyword selection screens 100A and 100B, a title of music data 101 that is in process of reproduction, extracted keyword candidate region 102 that displays extracted keywords, and a selected keyword region 103 that displays the keyword selected from the extracted keyword candidate region 102 are arranged near the center of the screen. The extracted keywords are displayed by buttons in the regions 102 and 103. On the bottom of the keyword selection screens 100A and 100B, a “PREVIOUS PAGE” button 104, a “NEXT PAGE” button 105, a “SELECTION CANCELING” button 106, and a “SETTING COMPLETION” button 107 are arranged for use when a lot of extracted keyword candidates and selected keywords and all of these cannot be displayed in the current display regions to allow browsing other extracted keyword candidates and selected keywords.

Whether the user selected a keyword out of the extracted keyword candidates 102 expressed as the buttons on the keyword selection screens 100A and 100B was judged (step S38). When the keyword out of the extracted keyword candidate region 102 expressed as buttons was selected (step S38, YES), the keyword expressed as a button is displayed in the selected keyword region 103 (step S39). Alternatively, when no keyword button of the extracted keyword candidate region 102 was selected (step S38, NO), whether the keyword button in the selected keyword region 103 was selected is judged (step S40). When the keyword button in the selected keyword region 103 was selected (step S40, YES), whether the selection canceling button 106 was pushed is further judged (step S41). When the selection canceling button was pushed (step S41, YES), the keyword button selected from the selected keyword region 103 is deleted (step S42). Thereafter, when the keyword button in the selected keyword region 103 was not selected in the step S40 (step S40, NO), or when the selection canceling button 106 was not pushed in the step S41 (step S41, NO), whether the setting completion button 107 was pushed is judged (step S43). When the setting completion button 107 was not pushed (step S43, NO), the control returns to the step S37 and the process of S37 to S42 is repeated until the setting completion button 107 is pushed.

For example, FIG. 10A shows a state in which a “GRASSLAND” button 102A that is expressed as hatched in the extracted keyword candidate region 102 is selected and “GRASSLAND” 103A is displayed in the selected keyword region 103. FIG. 10B indicates a state where the “NEXT PAGE” button 105 in FIG. 10A was pushed and a “STEROPE” button 102B that is hatched in the extracted keyword candidate region 103 is selected and “STEROPE” 103B is displayed in the selected keyword region 103.

When the setting completion button 107 on the keyword selection screens 100A and 100B at the step S43 (step S43, YES), the keyword displayed in the selected keyword region 103 is related to the music data reproduced at the step S31 and stored in the music database 21 (step S44), thus completing the keyword preparing process.

The reproduction processes includes those recording processes when the music data during reproduction are dubbed into other recording medium such as compact disc (CD) or mini disk (MD). When the music data recorded in other recording medium such CD or MD are recorded in the music data information storing unit 2 of the audio information reproducing apparatus 1a, keywords can be prepared by the above-mentioned process. The present invention is also applicable to audio information reproducing apparatus 1a that can perform dubbing at N×speed (where N is a number larger than 0). In this case, however, the speech recognizing unit 54 must have a recognition dictionary that is adapted to N×speed operation.

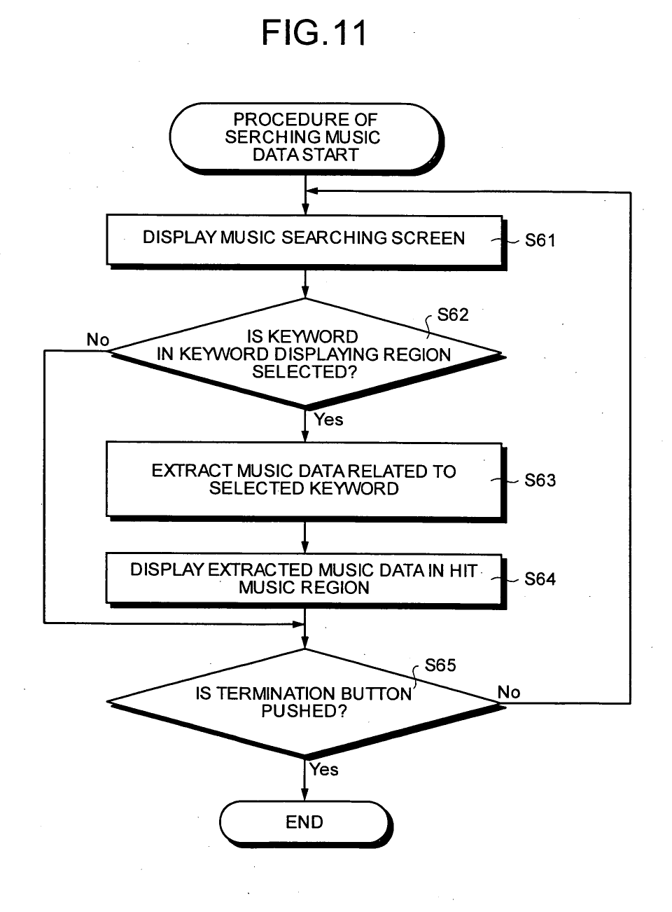

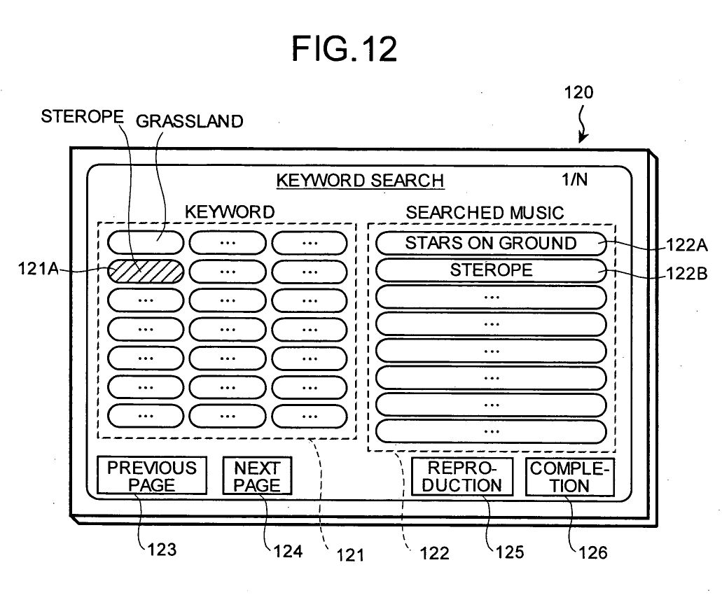

The music data searching process in the audio information reproducing apparatus 1a is explained. FIG. 11 is a flowchart of a procedure of searching music data using a keyword in an audio information reproducing apparatus. The music data searching process starts when the user gives instruction to start the keyword searching process, for example, pushes a music searching button 73 in the reproduction screen 70 in FIG. 7 while the audio information reproducing apparatus 1a is active, and the music searching screen is displayed on the touch panel 11 (step S61). FIG. 12 is a diagram of an example of a piece searching screen. A music searching screen 120 has a keyword displaying region 121 that displays keywords stored in the music data information storing unit 2 and a hit music displaying region 122 that displays the music data related to the selected keyword in the keyword display region 121 that are arranged near the center of the screen. In the regions 121 and 122, keywords or music title are indicated by buttons. On the bottom of the music searching screen 120, a “PREVIOUS PAGE” button 123, a “NEXT PAGE” button 124, a “REPRODUCTION” button 125 to reproduce the selected hit music, and a “COMPLETION” button 126 to terminate the keyword searching process are arranged for use when a lot of extracted keyword candidates and hit songs and all of these cannot be displayed in the current display regions to allow browsing other extracted keyword candidates and selected keywords.

The keyword searching unit 7 judges Whether a keyword in the keyword displaying region 121 was selected (step S62). When the keyword was selected (step S62, YES), the keyword searching unit 7 searches music data related to the selected keyword in the music database 21 (step S63) and displays the title of the music hit in the hit music displaying region 122 (step S64). For example, FIG. 12 indicates a state where a “STEROPE button 121A in the keyword region is selected and “STARS ON GROUND” 122A and “STEROPE” 122B that is a music related to “STEROPE” are extracted.

Thereafter, or when no keyword in the keyword displaying region 121 was selected at the step S62 (step S62, NO), whether the completion button 126 was pushed is judged (step S65). When the completion button 126 was not pushed (step S65, NO), the control returns to the step S61 and the above-mentioned process is repeated. When the completion button 126 was pushed, the music data searching process using keywords are terminated.

The music hit by the music data searching process using keywords can be reproduced as it is or after further selection by the user. When the audio information reproducing apparatus 1a has a program reproducing function, program may be reproduced by adding the title of the music that is hit or further selected. When the audio information reproducing apparatus 1a has a unique or appealing part (so-called “sabi” in Japanese) reproducing function, the unique or appealing part of the hit or further selected songs can be reproduced. When the audio information reproducing apparatus 1a has introduction scanning function, the introduction (starting part) of the hit or further selected music can be reproduced.

In stead of relating the keyword as a noun in the lyrics to the music data, the music data can be first grouped depending on the genre (tune) and the keyword as a noun in the lyrics can be related to the music data. The grouping makes it possible to use genre and words (nouns) in the lyrics as keywords, so that music data that are closer to the objective can be obtained during searching.

According to the example, the words in the vocal component of the music data are extracted as keywords and related to the music data. Accordingly, the user who knows the music data can search the music data with ease based on the contents of the lyrics. This leads to extraction of desired music data no matter who uses even when the audio information reproducing apparatus 1a having recorded therein a huge number of music data is used by a plurality of users. Since the keyword is selected from the words extracted from the lyrics of the reproduced music data, inputting the keywords is not cumbersome.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. An audio information reproducing apparatus comprising:
a storing unit that stores therein a plurality of music data and music data relating information that relates a keyword to each of the music data;
a reproducing unit that reproduces the music data;
an acquiring unit that acquires a keyword from a user;
a searching unit that searches the storing unit for music data relating to music data relating information corresponding to the keyword acquired;
an extracting unit that extracts characteristics of music data while the music data reproduces the reproducing unit; and
a preparing unit that prepares a keyword using the characteristics of the music data extracted by the extracting unit, causes the storing unit to store the music data and the keyword prepared in a correlated form.

2. The audio information reproducing apparatus according to claim 1, wherein the preparing unit holds music data characteristics information that describes correspondence between characteristics of the music data and the keywords, and extracts the keyword corresponding to the characteristics of music data extracted by the extracting unit.

3. The audio information reproducing apparatus according to claim 2, wherein the music data characteristics information describes correspondence between genre or tune of the music data and the keyword, and
wherein the extracting unit extracts the genre or tune of the music data.

4. The audio information reproducing apparatus according to claim 1, further comprising:
a displaying unit; and
an inputting unit,
wherein the searching unit displays the keywords stored in the storing unit in the displaying unit, and searches music data related to the keyword selected by the inputting unit from the displayed keywords in the storing unit, and displays the obtained music data in the displaying unit.

5. The audio information reproducing apparatus according to claim 1, wherein the reproduction by the reproducing unit includes reproduction of the music data stored in the storing unit, recording of the music data stored in the storing unit in another recording medium, or recording of music data in another recording medium into the storing unit.

6. An audio information reproducing apparatus comprising:
a storing unit that stores therein a plurality of music data and music data relating information that relates a keyword to each of the music data;
a reproducing unit that reproduces the music data;
an acquiring unit that acquires a keyword from a user;
a searching unit that searches the storing unit for music data relating to music data relating information corresponding to the keyword acquired;
a voice extracting unit that extracts voice from the music data reproduced by the reproducing unit;
a speech recognizing unit that performs voice recognition with respect to the extracted voice to extract a sequence of words;
a keyword extracting unit that extracts a word selected from the recognized words based on a predetermined standard as the keyword, relates the extracted keyword to the music data, and causes the storing unit to store the keyword.

7. The audio information reproducing apparatus according to claim 6, further comprising:
a displaying unit; and
an inputting unit;
wherein the searching unit displays words selected from the recognized keywords based on a predetermined standard in the displaying unit, relates a word out of the selected words indicated by the inputting unit to the music data as the keyword, and causes the storing unit to store the keyword.

8. The audio information reproducing apparatus according to claim 6, wherein the reproduction by the reproducing unit includes reproduction of the music data stored in the storing unit, recording of the music data stored in the storing unit in another recording medium, or recording of music data in another recording medium into the storing unit.

9. A method of preparing keywords for a plurality of music data used in an audio information reproducing unit that searches music data using a keyword and reproduces a desired music data, comprising:
extracting characteristics of the music data while the music data are reproduced; and
preparing a keyword using the characteristics of the music data extracted at the extracting and relating the keyword to the music data.

10. The method according to claim 9, wherein preparing includes preparing a keyword that corresponds to the characteristics of the music data extracted at the characteristics based on the music data characteristics information that describes correspondence between the characteristics of the music data and the keyword.

11. The method according to claim 10, wherein the music data characteristics information describes correspondence between genre or tune of the music data, and
wherein the extracting includes extracting genre or tune of the music data.

12. A method of preparing keywords for a plurality of music data used in an audio information reproducing unit that searches music data using a keyword and reproduces a desired music data, comprising:
extracting voice of the music data while the music data are reproduced;
performing speech recognition with respect to the voice extracted at the extracting as a sequence of words;
extracting a word out of the recognized words based on a predetermined standard as the keyword and relating the keyword to the music data.

13. The method according to claim 12, wherein the extracting includes relating the word selected from the extracted words as the keyword to the music data.
